(19) United States
(12) Patent Application Publication
(10) Pub. No.: US 2014/0067415 A1
(43) Pub. Date: Mar. 6, 2014

(54) SYSTEM AND METHOD FOR HEALTHCARE OPTION SELECTION

(71) Applicants: Johnathan Mun, Dublin, CA (US); Thomas Michael Schmidt, Iowa City, IA (US)

(72) Inventors: Johnathan Mun, Dublin, CA (US); Thomas Michael Schmidt, Iowa City, IA (US)

(21) Appl. No.: 14/016,650

(22) Filed: Sep. 3, 2013

Related U.S. Application Data
(60) Provisional application No. 61/696,394, filed on Sep. 4, 2012.

(51) Int. Cl. G06Q 50/22; G06Q 40/08

(52) U.S. Cl. CPC G06Q 50/22; G06Q 40/08
USPC 705/2

(57) ABSTRACT

The present invention is adapted to provide real health-care decision analysis, risk analysis, and option analytics to individual participants, the need for which has arisen from the passage of the Affordable Care Act. The system and process simulate, optimize and visualize individual health plan options. The optimization utility uses the carrier component pricing, actuarial value calculations and phantom rate development as the basis of valuation for each of the medical and pharmacy benefit plan design permutations. Employer sponsored insurance funding, legislated premium tax credits and cost sharing reductions and individual account based funding are all factored into the process. A detailed preference analytics algorithm is used to formulate the appropriate individual risk profile in order to map the options. The individual has the ability to simulate customized scenarios as part of the tier paths defined in the Affordable Care Act.

### CROSS REFERENCE TO RELATED APPLICATIONS

This application claims the benefit of U.S. Provisional Patent Application No. 61/696,394, filed Sep. 4, 2012, the entire disclosure of which is incorporated herein by reference.

The application also claims the benefit of U.S. Non-Provisional Utility patent application Ser. No. 13/786,786, filed Mar. 6, 2013, which claims priority to U.S. Provisional Patent Application No. 61/612,941, filed Mar. 19, 2012, the entire disclosure of both is incorporated herein by reference.

### FIELD OF THE INVENTION

The present invention is applicable in the fields of finance, health care, employee benefits, math, and business statistics and was originated to provide real health-care decision analysis, risk analysis, and option analytics to individual participants, the need for which has arisen from the passage of the Patient Protection and Affordable Care Act.

### COPYRIGHT AND TRADEMARK NOTICE

A portion of the disclosure of this patent document contains materials subject to copyright and trademark protection. The copyright and trademark owner has no objection to the facsimile reproduction by anyone of the patent document or the patent disclosure as it appears in the U.S. Patent and Trademark Office patent files or records, but otherwise reserves all copyrights whatsoever.

### BACKGROUND OF INVENTION

Individuals and families desire to know the financial implications resulting from the selection of a health plan option from among various options made available to them as purchasers of health plan coverage through an Affordable Insurance Exchange (Exchange) enabled by the Patient Protection and Affordable Care Act (Affordable Care Act), through an employer-sponsored health insurance arrangement or as an individual purchaser of health insurance coverage in the market; not as a participant in an employer-sponsored offering and not as a purchaser outside of an Exchange. The real cost for a plan option for many households must take into account both premium tax credits and cost-sharing reductions made available to them under the Affordable Care Act as subsidies for qualifying individuals and households who purchase coverage through an Exchange. However, many employees or individuals may not qualify for such subsidies and may not see the advantage in purchasing through an Exchange. Insurance carriers may elect not to participate as a supplier in providing coverage through an Exchange for a number of reasons: They may believe they would be subsidizing their competitors through the risk adjustment process mandated by the ACA for the Exchange; the specific state's legislation may be deemed ineffective with respect to enforcement of the level playing field rules and they see an opportunity to anti-select against the Exchange; and/or the 3:1 mandated rate structure restriction would force too much upward base rate pressure on their rating bands with the expected result of a loss of market share. Employers may continue to provide employer-sponsored health insurance coverage as part of a strategy that believes it is an important component in attracting and retaining talent; if they think that they have a demographic advantage when normalized against the Exchange population and that they have more insight and flexibility in plan offerings tailored to their population; if they are not satisfied with the quality of the insurance carriers participating in the Exchange; and if their financial experience is much more favorable through self-funding than that of a pooled population in general and the Exchange population in particular.

Therefore, there is need in the art for a computer-implemented system and method for providing analysis that individuals can use to assess the health insurance options available to them in the market. These and other features and advantages of the present invention will be explained and will become obvious to one skilled in the art through the summary of the invention that follows.

### SUMMARY OF THE INVENTION

The present invention, with its preferred embodiment encapsulated within Health Quant Individual Modeler (HQIM) software is applicable for the types of analyses that individuals will need to assess the options available to them in the market. The HQIM may be configured as (i) a stand-alone set of software modules, (ii) a server-based set of software modules, (iii) an advanced analytical tool set that is used to integrate demographics, preference analytics, premium tax credits, cost-sharing reductions, modeling, simulation, matrix, and dashboard capabilities, or (iv) any combination thereof. In certain embodiments, an HQIM may be attached to a Health Quant Data Modeler (HQDM) as an option for the employees of a population or as a detached capability.

According to an embodiment of the present invention, a computer program product for providing a process for healthcare plan selection includes: a nontransitory computer readable medium; and computer program code, encoded on the computer readable medium, comprising computer readable instructions for: obtaining demographic data for a healthcare consumer; obtaining said healthcare consumer's health profile data; obtaining one or more healthcare preferences of said healthcare consumer; determining whether said healthcare consumer is eligible for a premium tax credit and calculating said premium tax credit; determining whether said healthcare consumer is eligible for a cost sharing reduction and calculating said cost sharing reduction; running a simulation that predicts said consumer's claims over a period of time; determining said healthcare consumer's healthcare plan options based, at least in part, on one or more of the following: said demographic data, said health profile data, said healthcare preferences, said tax credit, said cost sharing reduction, and said predicted claims; and presenting said healthcare plan options to said healthcare consumer.

According to an embodiment of the present invention, the demographic data comprises said health consumer's household income.

According to an embodiment of the present invention, the demographic data comprises said health consumer's household total number of dependents.

According to an embodiment of the present invention, the healthcare preferences comprise risk tolerance.

According to an embodiment of the present invention, the healthcare preferences comprise said healthcare consumer's projected number of claims over a period of time.

According to an embodiment of the present invention, at least one of said selectable healthcare plan options is a recommended plan based, at least in part, on said healthcare preferences of said healthcare consumer.

According to an embodiment of the present invention, one of said selectable healthcare options is to decline insurance coverage and pay an associated tax penalty.

According to an embodiment of the present invention, the predicted number of claims is based, at least in part, on a confidence level.

According to an embodiment of the present invention, the healthcare options are ranked based, at least in part, on said predicted number of claims.

According to an embodiment of the present invention, the healthcare options comprise health insurance carrier names, plan names, plan levels, market rates, and design features.

According to an embodiment of the present invention, a system for providing selectable healthcare plans includes: a processor; a memory coupled to said processor, the memory having processor executable instructions stored therein, the processor executable instructions comprising: a business logic module, wherein said business logic module is configured to obtain demographic data for a healthcare consumer, obtain said healthcare consumer's health profile data, obtain one or more healthcare preferences of said healthcare consumer, determine whether said healthcare consumer is eligible for a premium tax credit and calculate said premium tax credit, determine whether said healthcare consumer is eligible for a cost sharing reduction and, calculate said cost sharing reduction, run a model simulation that predicts the number of claims for said consumer over a period of time, and determine one or more healthcare options for said healthcare consumer based, at least in part, on one or more of the following: said demographic data, said health profile data, said healthcare preferences, said premium tax credit, said cost sharing reduction, and said predicted number of claims; a data access module, wherein said data access module is configured to provide access to said healthcare consumer's data and any other data required to run said simulation; and a presentation module, wherein said presentation module presents said one or more healthcare options.

According to an embodiment of the present invention, the model simulation is a monte carlo simulation.

According to an embodiment of the present invention, the predicted number of claims is based, at least in part, on a confidence level.

According to an embodiment of the present invention, the model simulation predicts consumer costs associated with a selected plan.

According to an embodiment of the present invention, the healthcare preferences comprise risk tolerance.

According to an embodiment of the present invention, a computer implemented method for providing selectable healthcare plans includes the steps of: obtaining demographic data for a healthcare consumer; obtaining said healthcare consumer's health profile data; obtaining one or more healthcare preferences of said healthcare consumer; determining whether said healthcare consumer is eligible for a premium tax credit; calculating said premium tax credit; determining whether said healthcare consumer is eligible for a cost sharing reduction; calculating said cost sharing reduction; running a model simulation that predicts the number of claims for said consumer over a period of time; and determining one or more healthcare options for said healthcare consumer based, at least in part, on one or more of the following: said demographic data, said health profile data, said healthcare preferences, said premium tax credit, said cost sharing reduction, and said predicted number of claims.

### BRIEF DESCRIPTION OF THE DRAWINGS

FIG. 1 illustrates a schematic overview of a computing device, in accordance with an embodiment of the present invention.

FIG. 2 illustrates a network schematic of a system, in accordance with an embodiment of the present invention.

FIG. 3 illustrates the three layers: business logic, data access, and presentation, in accordance with an embodiment of the present invention.

FIG. 4 illustrates the individual modeler process map, in accordance with an embodiment of the present invention.

FIG. 5 is a process flow diagram showing an embodiment of the present invention, in accordance with an embodiment of the present invention.

### DETAILED DESCRIPTION OF THE INVENTION

The present invention is applicable in the fields of finance, health care, employee benefits, math, and business statistics and was originated to provide real health-care decision analysis, risk analysis, and option analytics to individual participants, the need for which has arisen from the passage of the Patient Protection and Affordable Care Act.

According to an embodiment of the present invention, the computer-implemented system and methods herein described may be configured to utilize one or more sets of models and algorithms.

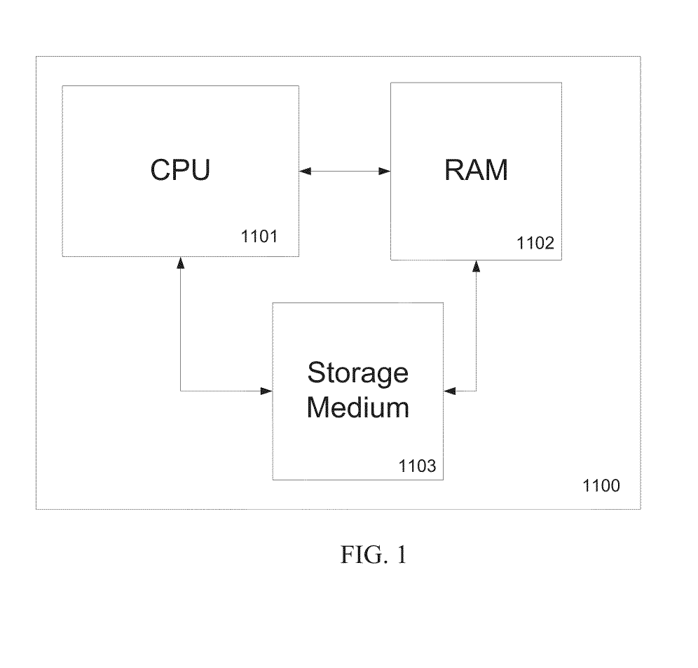

According to an embodiment of the present invention, the system and method are accomplished through the use of one or more computing devices. As shown in FIG. 1, one of ordinary skill in the art would appreciate that a computing device 1100 appropriate for use with embodiments of the present application may generally comprise one or more central processing unit (CPU) 1101, random access memory (RAM) 1102, and a storage medium (e.g., hard disk drive, solid state drive, flash memory, cloud storage) 1103. Examples of computing devices usable with embodiments of the present invention include, but are not limited to, personal computers, smart phones, laptops, mobile computing devices, tablet PCs, and servers. The term “computing device” may also describe two or more computing devices communicatively linked in a manner as to distribute and share one or more resources, such as clustered computing devices and server banks/farms. One of ordinary skill in the art would understand that any number of computing devices could be used, and embodiments of the present invention are contemplated for use with any computing device.

In an exemplary embodiment according to the present invention, data may be provided to the system, stored by the system, and provided by the system to users of the system across local area networks (LANs, e.g., office networks, home networks) or wide area networks (WANs, e.g., the Internet). In accordance with the previous embodiment, the system may comprise numerous servers communicatively connected across one or more LANs and/or WANs. One of ordinary skill in the art would appreciate that there are numerous manners in which the system could be configured, and embodiments of the present invention are contemplated for use with any configuration.

In general, the system and methods provided herein may be consumed by a user of a computing device whether connected to a network or not. According to an embodiment of the present invention, some of the applications of the present invention may not be accessible when not connected to a network; however, a user may be able to compose data offline that will be consumed by the system when the user is later connected to a network.

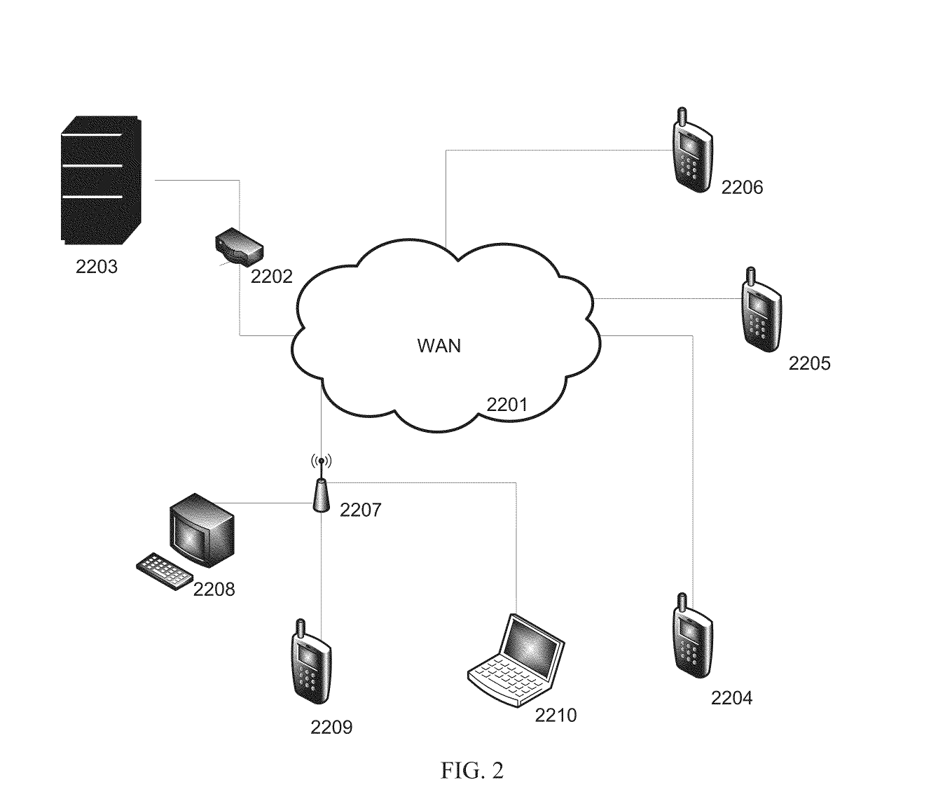

Referring to FIG. 2, a schematic overview of a system in accordance with an embodiment of the present invention is shown. The system consists of one or more application servers 2203 for electronically storing information used by the system. Applications in the application server 2203 may retrieve and manipulate information in storage devices and exchange information through a WAN 2201 (e.g., the Internet). Applications in a server 2203 may also be used to manipulate information stored remotely and to process and analyze data stored remotely across a WAN 2201 (e.g., the Internet).

According to an exemplary embodiment, as shown in FIG. 2, exchange of information through the WAN 2201 or other network may occur through one or more high-speed connections. In some cases, high-speed connections may be over-the-air (OTA), passed through networked systems, directly connected to one or more WANs 2201, or directed through one or more routers 2202. Router(s) 2202 are completely optional, and other embodiments in accordance with the present invention may or may not utilize one or more routers 2202. One of ordinary skill in the art would appreciate that there are numerous ways a server 2203 may connect to WAN 2201 for the exchange of information, and embodiments of the present invention are contemplated for use with any method for connecting to networks for the purpose of exchanging information. Further, while this application refers to high-speed connections, embodiments of the present invention may be utilized with connections of any speed.

Components of the system may connect to a server 2203 via WAN 2201 or other network in numerous ways. For instance, a component may connect to the system (i) through a computing device 2212 directly connected to the WAN 2201; (ii) through a computing device 2205, 2206 connected to the WAN 2201 through a routing device 2204; (iii) through a computing device 2208, 2209, 2210 connected to a wireless access point 2207; or (iv) through a computing device 2211 via a wireless connection (e.g., CDMA, GMS, 3G, 4G) to the WAN 2201. One of ordinary skill in the art would appreciate that there are numerous ways that a component may connect to a server 2203 via WAN 2201 or other network, and embodiments of the present invention are contemplated for use with any method for connecting to a server 2203 via WAN 2201 or other network. Furthermore, a server 2203 could be a personal computing device, such as a smartphone, acting as a host for other computing devices to connect to.

According to an embodiment of the present invention, the following is a detailed description of HQIM as it updates and expands demographic information, establishes the algorithms to analyze preferences, formulates the short- and long-term methodologies for calculating premium tax credits and cost-sharing reductions, running Monte Carlo risk and uncertainty simulations, performing data visualization, and generating graphical representations.

### Demographics

According to an embodiment of the present invention, a default census may populate HQIM from HQDM if added as a module. Census information may be reviewed, entered, reentered, or adjusted by the user to reflect the exact demographic information needed for model. In a preferred embodiment, the information required to create the most accurate representation of the premium tax credits and cost-sharing reductions include household income and the number of tax-deductible dependents.

According to an embodiment of the present invention, premium tax credit calculations used in HQDM are based upon income reported from the census imported from the employer using HQDM where eligibility for premium tax credits and cost-sharing reductions is based upon that individual's income as the basis for household income and where all dependents listed are deemed tax-deductible dependents. In a preferred embodiment, an individual's inclusion of additional income sources (e.g., interest, investment, spousal) and any adjustment to the number of dependents provides the baseline for the premium tax credits and cost-sharing reductions. The terms “census information” and “demographic data” shall be regarded as equivalent terms throughout this application.

### Preference Analytics

According to an embodiment of the present invention, the preference analytics tools are designed to determine the individual's risk appetite. In a preferred embodiment, this determination is made through a series of simplified questions and answers that lead to an optimal plan selection from among the available plan choices.

According to an embodiment of the present invention, the preference analytics questions are iterative in that the answer to one question pivots to create a different set of questions to be asked. In a preferred embodiment, questions including, but not limited to, whether the individual is risk averse or risk assumptive; whether the individual wants freedom of choice in their provider selection; if there is an acute health condition and disruption is a concern because of an ongoing treatment regimen; and if specific medications are on a Qualified Health Plan (QHP) issuer's preferred formulary that will drive the decision are posed to the individual. Additional embodiments include an option not to purchase coverage and pay the penalty tax as well as model other anti-selection options.

### Premium Tax Credits

According to an embodiment of the present invention, premium tax credits are advance payments from the federal government to QHP issuers on behalf of specific individuals determined eligible for these subsidies based upon the cost of the second-lowest cost silver plan, state of residency, household income, and the number of tax eligible dependents.

According to an embodiment of the present invention, the first step in calculating the premium tax credit amount is to determine eligibility by indexing and matching household income with the number of dependents to the appropriate state of residency federal poverty level table to establish if they are eligible for the credit and the threshold percentage of income. In a preferred embodiment, the only calculations made are for individuals above Medicaid eligibility and below 400% of the federal poverty level (FPL). This threshold of income percentage is based upon the federal poverty level tables (updated and published annually) with the current level of income percentages as noted in the following calculation methodology outlined in the Affordable Care Act: <133% of FPL (2% of household income), 133% to 150% of FPL (3% of household income), 150% to 200% of FPL (6.3% of household income), 200% to 250% of FPL (8% of household income), >250% of FPL (9.5% of household income).

According to an embodiment of the present invention, the second step is to source the premium for the second-lowest cost silver plan sourced from the Affordable Insurance Exchange data tables (current placeholder data is Office of Personnel Management's [OPM] Blue Cross Blue Shield Standard Rates; rate data that is updated annually to reflect OPM's negotiated rates and replaceable with any other data source we deem is more representative) and compute the dollar amount an individual or family is capped at contributing toward the cost of health care by multiplying this threshold percentage of income by the premium.

According to an embodiment of the present invention, the third step is to subtract this dollar amount from the second-lowest cost silver plan premium to determine the premium tax credit amount.

The referenced Affordable Insurance Exchange data tables are in development by both state-based and federally facilitated exchanges. The expectation is that this information will be made public and these data tables will be available for the indexing and matching function.

### Cost-Sharing Reductions

According to an embodiment of the present invention, cost-sharing reductions are reductions to out-of-pocket costs that are advanced to QHP issuers (health insurance and managed care companies) from the federal government as mandated by the Affordable Care Act for individuals and families who qualify based upon the cost of the second-lowest cost silver plan, state of residency, household income, and the number of tax eligible dependents. The proposed approach by the Department of Health and Human Services (HHS) is that at the point of enrollment, the Affordable Insurance Exchange will determine the eligibility for the cost-sharing reduction. This determination will trigger advance payments to QHP issuers from the federal government to cover the projected cost of these cost-sharing reductions on a monthly basis with an annual reconciliation process. In a preferred embodiment, a process of the present invention will calculate these cost-sharing reductions for the individual and family independent of the federal government's projections and smoothing payments to QHP issuers to provide an estimate based upon individual expectations and assumptions.

Section 1402(a)-(c) of the Affordable Care Act directs QHP issuers to reduce cost-sharing on essential health benefits (EHB) for an individual with a household income of or below 400% of the Federal Poverty Level (FPL) who enrolls in a silver-level qualified health plan in the individual market through an Affordable Insurance Exchange. The statute directs that this reduction should be achieved by reducing the out-of-pocket limit and then by reducing deductibles, copayments, and coinsurance only for those individuals deemed eligible for a premium tax credit and enrolled in a silver-level plan. It is expected by HHS that at some future point in time QHP issuers will offer specific silver plan variations that meet the respective actuarial value tests and out-of-pocket reductions. According to an embodiment of the present invention, when these silver plan variations are known and noted, this calculation component will revert to an indexing and matching function for the individual and family to map them to the second-lowest cost silver plan variation that meets the actuarial value requirement and cost-sharing reduction amounts. In a preferred embodiment, the difference in premium will be calculated as the difference in the premium between the silver plan without cost-sharing subsidization and the premium for the second-lowest cost silver plan (with variation that meets the actuarial value requirement and cost-sharing reduction amounts) and will be used as the basis for illustrating the cost-sharing reduction amount.

According to an embodiment of the present invention, prior to the date when the silver plan variations are known and noted, the present invention will calculate the cost-sharing reductions for an individual and family based upon the statutory reductions to the out-of-pocket limits. These out-of-pocket limits are for qualified high-deductible health plans, updated and published annually by the Treasury Department, and currently set at $6,250 (individual) and $12,500 (family) for 2013.

According to an embodiment of the present invention, the first step in calculating the cost-sharing reduction is to take user-estimated claims projections (see “Preference Analytics”) and calculate the out-of-pocket costs for the individual or family using the plan design of the second-lowest cost silver plan net of cost-sharing subsidization.

According to an embodiment of the present invention, the second step is to take only those individuals eligible for the premium tax credit and match these individuals to the cost-sharing reductions (one-third, one-half, and two-thirds of the lesser of the silver plan out-of-pocket limit or the qualified high-deductible health plan limits).

According to an embodiment of the present invention, the third step is to take these same user-estimated claims projections and calculate the out-of-pocket costs for the individual or family using the plan design of the second-lowest cost silver plan applying these cost-sharing reductions.

According to an embodiment of the present invention, the fourth step is to simulate the distribution of the net cost using multiple methods—custom-defined ranges set by the user and predefined ranges set as defaults. The following describes the federal poverty level table match, the statutory reduction in the out-of-pocket (OOP) limits, and the actuarial values (each to be updated annually) outlined in the Affordable Care Act: 100% to 150% FPL (a two-thirds OOP limit reduction with the actuarial value not to exceed 94%), 150% to 200% FPL (a two-thirds OOP limit reduction with the actuarial value not to exceed 87%), 200% to 250% FPL (a one-half OOP limit reduction with the actuarial value not to exceed 73%), 250% to 300% FPL (a one-half OOP limit reduction with the actuarial value not to exceed 70%), and 300% to 400% FPL (a one-third OOP limit reduction with the actuarial value not to exceed 70%).

### Modeling and Simulation

According to an embodiment of the present invention, the modeling and simulation function is designed to allow the individual to enter his/her estimate of total claims for a twelve-month period and provide answers to a simplified question-and-answer algorithm designed to create a customized set of input assumptions. In a preferred embodiment, these input assumptions are specifically designed to capture variability in the claims and build in preference selections, plan design selections, and the level of certainty in the results. The full scope of HQDM simulation capabilities is integrated into this function.

According to an embodiment of the present invention, the user will be allowed to opt for one of two road maps when creating a simulation model. In a preferred embodiment, one of the road maps is a customized path where the individual sets and resets claim estimates and the number of simulations for active modeling, and the other is a default option where the following options are modeled—bronze, silver, gold, and platinum under user-based claim estimates.

### Dashboard and Matrix

According to an embodiment of the present invention, the Options Matrix dashboard for HQIM will simulate gross claims, plan liability, and/or individual net cost for each/all of the options selected by the individual, and show the frequency, cumulative probability, dollar amounts under a two-tail distribution showing the upper and lower limits, and a selection tool that allows the user to pick the confidence interval (e.g., 80%, 85%, 90%, etc.). In a preferred embodiment, the options may consist of a bronze plan option (60% actuarial value), a silver plan option (70% actuarial value and the default plan option), a gold plan option (80% actuarial value), a platinum plan option (90% actuarial value), and an optimal option (based upon preference analytics).

According to an embodiment of the present invention, a separate two-by-two matrix will summarize the critical information for each of the options and may be viewed as one option in each quadrant or as one two-by-two graphic within one of the quadrants. In a preferred embodiment, the default two-by-two matrix will be populated with the silver plan (lower-left quadrant), the optimal, best-fit plan (upper-left quadrant), the bronze plan (upper-right quadrant), and the opt-out option (lower-right quadrant). The information in the matrix for each of the options will contain option name, total annual premium, total net cost for no claims, total net cost for median claims, total net cost for average claims, total net cost for maximum claims, total net cost for minimum claims, premium tax credits, and cost-sharing reductions, and will show two recommended plan design options based upon the preference analytics selected.

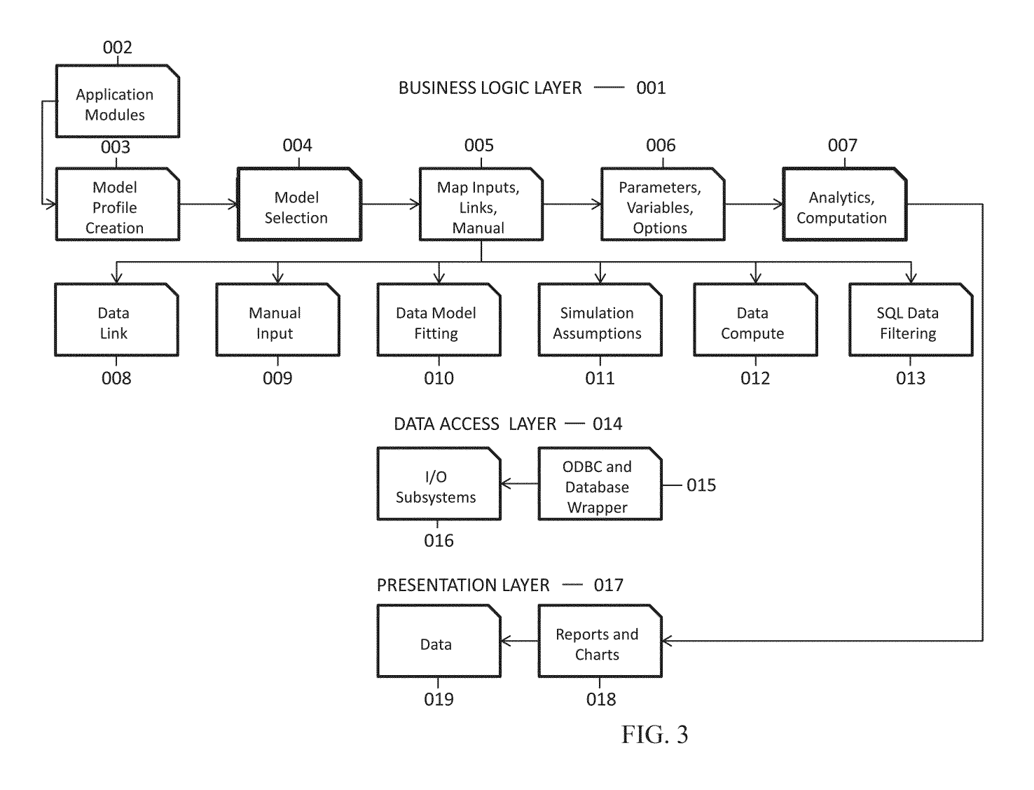

FIG. 3 illustrates the underlying infrastructure of an embodiment of the present invention. In this preferred embodiment, three layers are utilized: a business logic layer, a data access layer, and a presentation layer. The business logic layer 001 contains the application modules 002, that is, the mathematical and financial models, where the user first creates a profile 003 that stores all the input assumptions and then selects the relevant model 004 to run. When the model is selected, the system automatically requests that the required input parameters be mapped 005. Several methods exist for the user at this point to decide where the input data comes from—through some existing data files or database 008; manual inputs through directly typing data into the software 009; using existing data to fit into mathematical distributions through statistical fitting routines 010; or without the use of existing data—to set Monte Carlo simulation parameter assumptions 011, a combination of these approaches through a data compute module 012 by modifying existing variables or through creation of a new variable through the use of SQL expressions 013. One of ordinary skill in the art would appreciate that there are numerous methods for receiving input data, and embodiments of the present invention are contemplated for use with any method for receiving input data.

According to an embodiment of the present invention, if databases, data tables, or data files are used and linked in the business logic layer 001, then the method accesses the data access layer 014 through calling a proprietary database wrapper 015 and input-output (I/O) subsystems 016. On completing the variable mapping step 005, the user then sets up the parameters and enters the variables or selects the options 006. Then the analytics and computations occur 007, developing the presentation layer 017 that generates the relevant charts and statistics 018 and allows the computed results to be extracted as flat text files or data tables back into the database 019 as new variables.

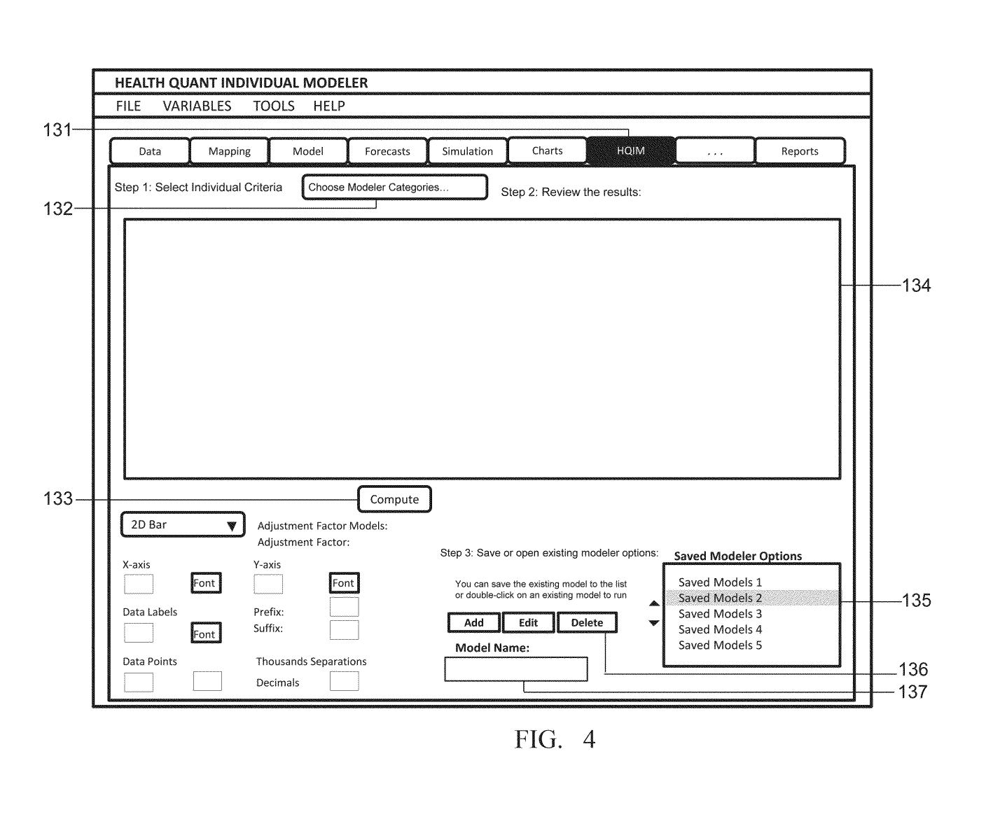

FIG. 4 illustrates the individual modeler process, in accordance with an embodiment of the present invention, through a user interface. The modeler application creates a unique individual custom-built option model by integrating the optimization, simulation, and real options analysis functionalities as described previously. The process is initiated by selecting the individual modeler function tab (HQIM) 131. The modeler categories 132 include a listing of options from among a drop-down list of options that populate the model with carrier names, plan names, plan levels, market rates, and design features. The user enters expected claims, tax rates, confidence levels desired, and constraints (e.g., budget constraints). The modeler will run a Monte Carlo risk simulation 133 and provide a graphical output of expected claims within the confidence intervals selected. An optimization is run that ranks each of the options ranging from noncompliance with penalty to the optimal match based on the confidence level chosen. The plans are ranked and graphed as a histogram or chart, with a supporting rates table 134. Models can be named 137 and saved (edited and/or deleted) 136, and are retrievable 135 at a future date.

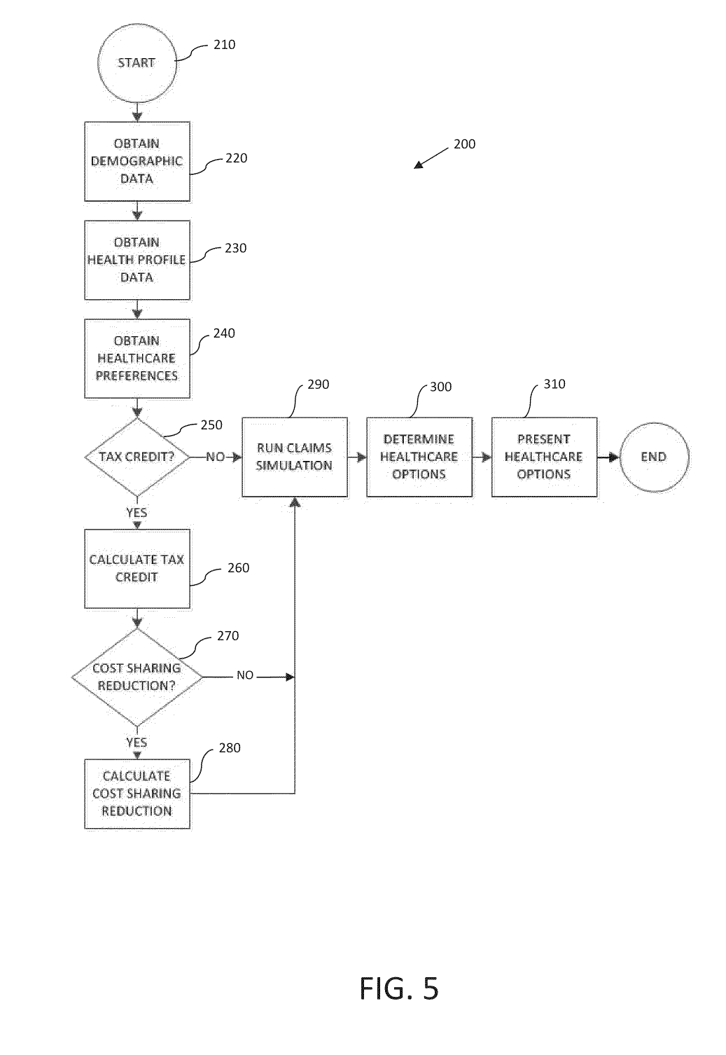

FIG. 5 illustrates a process for identifying healthcare options and presenting them to a user for selection 200 in accordance with an embodiment of the present invention. The process begins at operation 210 and proceeds to operation 220 where it obtains demographic data about the healthcare consumer by prompting the user for information, retrieving the information from an accessible memory location. Next, the process flows to operation 230 where it obtains health profile data of the healthcare consumer by prompting the user, or accessing an accessible memory location. The process next proceeds to operation 240 to obtain healthcare preferences of the healthcare consumer by prompting the user, or retrieving the information from an accessible memory location.

The process then proceeds to operation 250 to determine the healthcare consumer's eligibility for a premium tax credit based on the inputted information (i.e. demographic data, health profile data, and preference data). If the healthcare consumer is eligible for a premium tax credit, the process proceeds to operation 260 where it calculates the available tax credit, as previously discussed. However, if the healthcare consumer is not eligible for the premium tax credit, the process proceeds to claims simulation 290 to determine the anticipated number of claims for the healthcare consumer over a particular period of time. In addition, the claims simulation operation 290 may produce a random set of variable claims to simulate various health care options based on the variable number of claims. Once the claims simulation has run, the process flows to operation 300 to determine available healthcare options. These healthcare options are then presented to the user in operation 310.

If the premium tax credit is available and calculated, the process will proceed to operation 270 to determine whether the healthcare consumer is eligible for any cost sharing reduction. If the healthcare consumer is eligible for a cost sharing reduction, the process proceeds to operation 280 where it calculates the cost sharing reduction. The process then proceeds to run claims simulation 290, determine healthcare options 300, and present these options 310 to the user, as discussed above. One of ordinary skill will appreciate that the user may be the healthcare consumer, or an agent of the healthcare consumer. In addition, any of the inputted values discussed herein could be randomly generated values, or any other inputted/selected values for purposes of simulating various healthcare option outcomes. Furthermore, one of ordinary skill will appreciate that the above-described operations of process 200 may be performed in any order, and one or more operations may be skipped at the discretion of the user.

Available healthcare options may be presented to the user in the matrix format previously described. The healthcare options may also be ranked based on strength of recommendation, cost, quality, reputation, size, resources, rating, risk to insured, size of health provider network, or on any other criteria.

As described above, the present invention encompasses a computer-implemented method and system for selecting a healthcare plan. With this invention individuals may select a healthcare plan from a variety of healthcare options that is most suited to fill the individual's needs.

In the foregoing specification, the present invention has been described with reference to specific embodiments. However, one of ordinary skill in the art will appreciate that various modifications and changes may be made without departing from the spirit and scope of the present invention as set forth in the appended claims. Accordingly, the specification and drawings are to be regarded in an illustrative rather than a restrictive sense, and all such modifications are intended to be included within the scope of the present invention.

Benefits, other advantages, and solutions to problems have been described above with regard to specific embodiments of the present invention. However, the benefits, advantages, solutions to problems, and any element(s) that may cause or result in such benefits, advantages, or solutions to become more pronounced are not to be construed as a critical, required, or essential feature or element of any or all the claims. The invention is defined solely by the appended claims including any amendments made during the pendency of this application and all equivalents of those claims as issued.

1. A computer program product for providing a process for healthcare plan selection comprising:
a nontransitory computer readable medium; and
computer program code, encoded on the computer readable medium, comprising computer readable instructions for:
obtaining demographic data for a healthcare consumer;
obtaining said healthcare consumer's health profile data;
obtaining one or more healthcare preferences of said healthcare consumer;
determining whether said healthcare consumer is eligible for a premium tax credit and calculating said premium tax credit;
determining whether said healthcare consumer is eligible for a cost sharing reduction and calculating said cost sharing reduction;
running a simulation that predicts said consumer's claims over a period of time;
determining said healthcare consumer's healthcare plan options based, at least in part, on one or more of the following: said demographic data, said health profile data, said healthcare preferences, said tax credit, said cost sharing reduction, and said predicted claims; and
presenting said healthcare plan options to said healthcare consumer.

2. The computer program product of claim 1, wherein said demographic data comprises said health consumer's household income.

3. The computer program product of claim 1, wherein said demographic data comprises said health consumer's household total number of dependents.

4. The computer program product of claim 1, wherein said healthcare preferences comprise risk tolerance.

5. The computer program product of claim 1, wherein said healthcare preferences comprise said healthcare consumer's projected number of claims over a period of time.

6. The computer program product of claim 4, wherein at least one of said selectable healthcare plan options is a recommended plan based, at least in part, on said healthcare preferences of said healthcare consumer.

7. The computer program product of claim 1, wherein one of said selectable healthcare options is to decline insurance coverage and pay an associated tax penalty.

8. The computer program product of claim 1, wherein said predicted number of claims is based, at least in part, on a confidence level.

9. The computer program product of claim 7, wherein said healthcare options are ranked based, at least in part, on said predicted number of claims.

10. The computer program product of claim 1, wherein said healthcare options comprise health insurance carrier names, plan names, plan levels, market rates, and design features.

11. A system for providing selectable healthcare plans comprising:
a processor;
a memory coupled to said processor, the memory having processor executable instructions stored therein, the processor executable instructions comprising:
a business logic module,
wherein said business logic module is configured to
obtain demographic data for a healthcare consumer,
obtain said healthcare consumer's health profile data,
obtain one or more healthcare preferences of said healthcare consumer,
determine whether said healthcare consumer is eligible for a premium tax credit and calculate said premium tax credit,
determine whether said healthcare consumer is eligible for a cost sharing reduction and calculate said cost sharing reduction,
run a model simulation that predicts the number of claims for said consumer over a period of time, and
determine one or more healthcare options for said healthcare consumer based, at least in part, on one or more of the following: said demographic data, said health profile data, said healthcare preferences, said premium tax credit, said cost sharing reduction, and said predicted number of claims;
a data access module,
wherein said data access module is configured to provide access to said healthcare consumer's data and any other data required to run said simulation; and
a presentation module,
wherein said presentation module presents said one or more healthcare options.

12. The system of claim 10, wherein said model simulation is a monte carlo simulation.

13. The system of claim 10, wherein said predicted number of claims is based, at least in part, on a confidence level.

14. The system of claim 10, wherein said model simulation predicts consumer costs associated with a selected plan.

15. The system of claim 10, wherein said healthcare preferences comprise risk tolerance.

16. A computer implemented method for providing selectable healthcare plans, said method comprising the steps of:
obtaining demographic data for a healthcare consumer;
obtaining said healthcare consumer's health profile data;
obtaining one or more healthcare preferences of said healthcare consumer;
determining whether said healthcare consumer is eligible for a premium tax credit;
calculating said premium tax credit;
determining whether said healthcare consumer is eligible for a cost sharing reduction;
calculating said cost sharing reduction;
running a model simulation that predicts the number of claims for said consumer over a period of time; and
determining one or more healthcare options for said healthcare consumer based, at least in part, on one or more of the following: said demographic data, said health profile data, said healthcare preferences, said premium tax credit, said cost sharing reduction, and said predicted number of claims.
